(19) United States
(12) Patent Application Publication
(10) Pub. No.: US 2007/0066203 A1
(43) Pub. Date: Mar. 22, 2007

(54) System for the control of painting process in a spray booth, and spray booth therefor

(76) Inventor: Giovanni Melegatti, Verona (IT)

Correspondence Address: BROWDY AND NEIMARK, P.L.L.C.;624 NINTH STREET, NW, SUITE 300, WASHINGTON, DC, 20001-5303, US

(21) Appl. No.: 10/556,510

(22) PCT Filed: May 12, 2003
(86) PCT No.: PCT/IT03/00283

§ 371 Date: Nov. 9, 2006

(51) Int. Cl. B05B 15/12

(52) U.S. Cl. 454/52

(57) ABSTRACT

A system for the control of the painting process in a spray furnace booth is provided, comprising a first ventilation group for the inlet air to the booth, a second ventilation group to extract air from said booth, a device for heating the inlet air into the booth and a device for detecting the environment pressure inside the booth, the system is characterized in that it further comprises a central control unit of the PLC type connected to said first ventilation group, said second ventilation group, said device for heating the air and said device for detecting the pressure.

The present invention relates to a system for the control of painting process in a spray booth and, more precisely, the invention relates to a spray booth which incorporates a system for the control of all the steps of the painting process.

In the art, spray booths are already known where, in appropriate painting plants, it is possible to perform all the steps of a painting cycle for an article and that is, for example, surface cleaning, surface activation, first paint coating, additional paint coating, drying and surface final coat. In such booths, the painting cycle is performed in a substantially controlled manner by an operator and following some parameters set by the process and by the manufacturer of the paint to be applied such as temperature of the painting environment, humidity, rate of a drying air flow, etc.

Furthermore, considering that the painting cycle sometimes requires temperatures of the painting environment higher than the one of the environment surrounding the booth, the so-called “furnace booths” are implemented to this purpose. The furnace booth is substantially a closed structure in the inside thereof a certain quantity of air at a temperature set by the operator (the temperature also depends upon the kind of paint used, upon the brand, etc) is made to circulate forcedly. To do this, a first device for inletting hot air and a second device for extracting air from/towards the furnace booth are provided, which second device is substantially constituted by two groups of controlled ventilation and each device is provided with specific groups for filtering the air taken for obvious reasons.

For the painting process the furnace booth is further kept under slight pressure (between 1 and 6 mmH₂O) with respect to the outside to avoid that the dirty in the surrounding area of the booth may enter during the doors' opening. The pressure inside the booth is readable on a manometer placed near a control panel and it must be kept constantly under control to determine the obstruction level of discharge filters.

In a traditional furnace booth there are two processing steps: painting and drying.

Painting Step

The fresh air sucked from outside by the inlet group is pre-filtered, heated at set temperature, put into the plenum and re-filtered through the filters of the booth ceiling. Then, the air is uniformly distributed by crossing vertically the booth from the top downwards. The paint pigments in suspension with air are retained by dry filters placed under the gratings. The exhaust air is then expelled outside through a discharge duct by a sucking group. The so implemented circuit allows the total change of air during painting.

Drying Step

The ventilation group inlets air into the pre-filtering chamber, where is depurated upon crossing some filters. Subsequently the air is conveyed and brought in the meantime at the drying temperature by means of an air heating device, such as for example a burner, towards the plenum and through the ceiling equipped with filtering panels, it is inlet in the furnace booth. Then, it flows towards the discharge conveyed by the sucking group.

In such process the air circulates between the booth and the (heat) generator. To this purpose, a gate intercepting door is provided on the inlet duct to reverse the cycle when in “DRYING” position. In this way it is possible dosing the quantity of inlet air (10%-15% of total volume) necessary for the solvent evaporation, by reintegrating the cycle with a corresponding quantity of fresh air taken from the outside. The so implemented circuit allows the partial change of air in the booth during the drying step.

On the other hand, depending upon the kind of used paint (traditional solvent paints or cold-water new paints) and upon the booth sizes, it is provided that the ventilation group use electric motors with various powers (typically, for example ranging from 5.5 CV to 15 CV). In this way, different air quantity and speed are obtained.

However, the so constituted furnace booth of the state of the art has first drawback which is given by the fact that the operator not always needs the same (that is maximum) rate of supplied air during the whole working cycle, therefore there is a further consumption of the motor supplied power which is not necessary, to the detriment of a high consumption of electric energy. In fact, based upon the experiences reported by the users of furnace booths, and by the paints' manufacturing houses themselves, it results that instead of the past two traditional steps, nowadays and with the coming of the cold-water paints, one has moved towards several steps, where the air speed and the rate can or must be always different.

To solve such drawback, it has been suggested the use of “inverters” devices applied to the electric motors of the ventilation group in order to regulate the power supplied to the electric motor and, thus, the rate thereof.

Even if such solution appear ameliorative as far as the electric energy consumption is concerned, however it does not full satisfy the needs of the users of this field. In fact, the adjustment of the power supplied to the electric motors by means of inverters takes place not in real time, but by means of a control preset by the operator in a scale of predefined values, for example minimum/medium/maximum rate which does not fully satisfy the needs of the parameters necessary in almost all cycles as far as the aspect of the real measured consumption of electric energy is concerned.

Therefore, the object of the present invention is to solve the abovementioned disadvantages and drawbacks by providing a system for the control of the painting process in a spray booth which provides the control in real time the parameters preset by the operator during the whole painting and drying cycle of a product to be processed.

Another object of the present invention is to provide a system for the control of the painting process in a spray booth which provides the control and reduction of the energy consumption when necessary during the whole painting and drying process.

An additional object of the present invention is to provide a system for the control of the painting process in a spray booth which provides the reduction, in a particularly efficient way, of the time necessary to perform the whole painting and drying process with consequent saving in costs and production.

Another object of the present invention is to provide a spray booth incorporating the control system according to the present invention.

Therefore, the present invention provides a system for the control of the painting process in a furnace booth comprising the features described in the preamble of the first claim, which is characterized by the features described in the characterizing part of the first claim.

Furthermore, the present invention provides a spray furnace booth comprising such control system of the present invention.

A detailed description of a preferred embodiment of the system for the control of a painting process and spray booth for such process according to the present invention will be provided, given by way of example and not for limitative purposes, by referring to the enclosed drawings wherein:

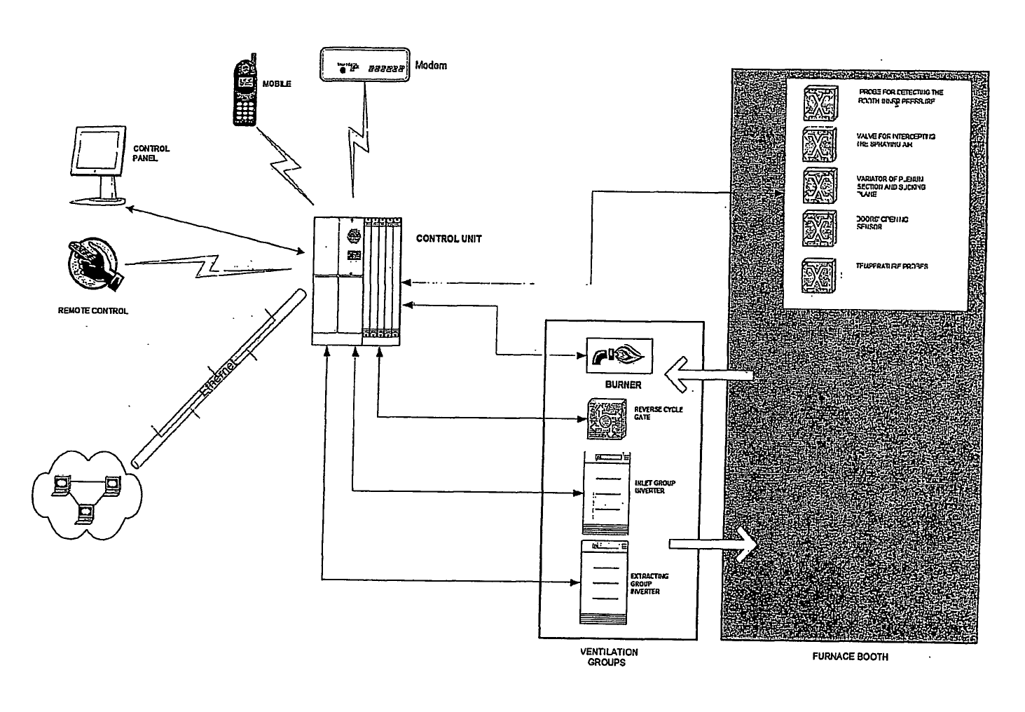

FIG. 1 is a schematic view illustrating the operating and function of the control system of the present invention; and

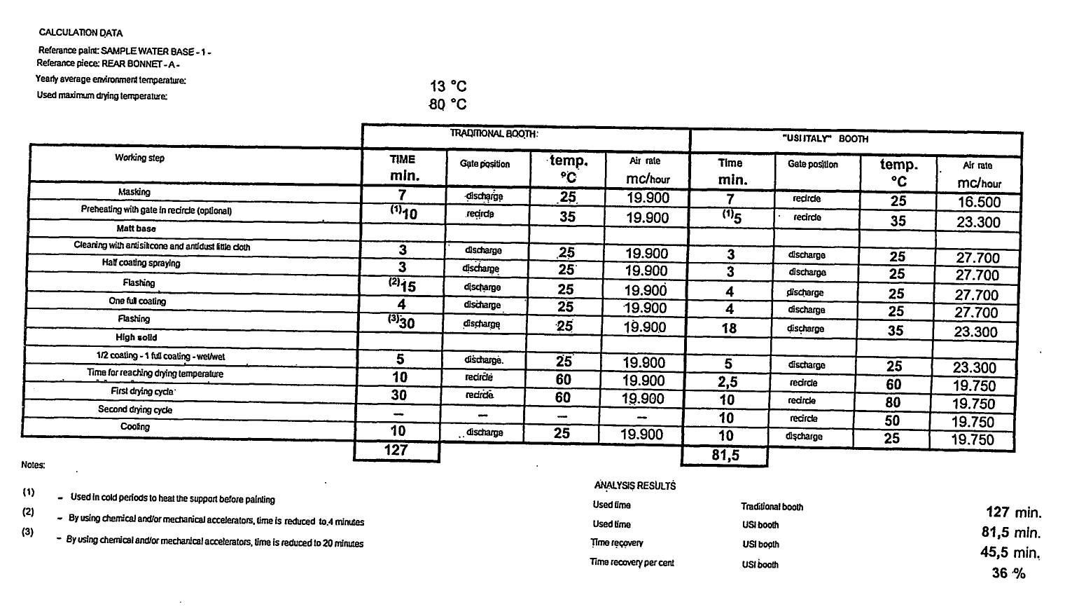

FIG. 2 is a table showing the process time of a traditional furnace booth and of a furnace booth incorporating the control system of the present invention.

By now referring to FIG. 1, the logical scheme of the control system according to the present invention is illustrated therein.

The system provides a control unit (PLC) placed outer the spray furnace booth. The control unit is connected by electric circuits with the ventilation groups which substantially comprise a device for heating the air such as for example a burner, a ventilating group for inletting air into the booth, a ventilating group for extracting air from the booth and an interception gate at the ventilation duct to intercept and reverse the air flow in the booth. Each ventilating group comprises a fan associated to an electric motor, a filtering group and an inverter associated to the electric motor. All these devices are interfaced to the control unit and managed by the same.

On the other hand, in the spray furnace booth there are provided a probe for detecting the inner pressure of the booth, a valve device for intercepting the air for the spraying process, a sensor of the opened/closed condition of the booth doors, one or more probes for detecting the inner environment temperature of the booth, and a changer device for varying the area (or the section) of plenum and of the air intake plane of the same. All these devices are interfaced to the control unit and they are managed by it.

Furthermore, the control unit has a control panel with a display to set all parameters and for managing and controlling the abovementioned devices by an operator. In fact, by means of the control panel it is possible to select and/or customize the operating working cycles of the used painting product and, in this way, the operator can easily change the settings of the painting and drying cycle.

The combination of the above mentioned devices interfaced to the central control unit allows managing in real time and in optimum way each step of the painting and drying cycle.

The painting process deriving from the control system of the present invention has several cycles, which can be synthetically schematized as in the table shown below:

TABLE 1

| STEPS/ | SET | SET | FREQUENCY | | | |
|---|---|---|---|---|---|---|
| WORKING | TEMPERATURE | TIME | [HZ] | | | GATE |
| CYCLES | ° C. | [MINUTES] | AV1 | AV2 | PAR | POSITION |
| MASKING | 25 | — | 20 | 15 | SP4 | DISCHARGE |
| PAINTING | 25 | — | 40 | 35 | SP7 | DISCHARGE |
| WATER BASE | 30 | 10 | 50 | 45 | SP6 | RECIRCLE |
| PREHEATING or | 40 | 10 | 35 | 15 | SP3 | RECIRCLE |
| RECIRCLE | | | | | | |
| FLASHING | | | | | | |

AUTOMATIC CYCLE

| | | | | | | |
|---|---|---|---|---|---|---|
| 1. FLASHING | 30 | 0-10 | 40 | 35 | SP7 | DISCHARGE |
| 2. DRYING 1 | 80 | 10 | 35 | 15 | SP2 | RECIRCLE |
| 3. DRYING 2 | 60 | 10 | 35 | 15 | SP2 | RECIRCLE |
| 4. COOLING | 25 | 10 | 40 | 35 | SP7 | DISCHARGE |

Where:
AV1: AIR INLET FAN
AV2: AIR EXTRACTION FAN

As it can be interpreted by the table, the management of the whole painting and drying cycle by the central unit allows having a rate of optimum air for each working step.

Furthermore, the interfacing of the central unit to the gate for the reversal cycle allows-actuating the same in very short time with respect to the arrangements of the booths of the state of art. In fact, in traditional booths in order to pass from the “air change” step to the “recycling” step servomotors are used to move a gate, with an actuating time which lasts several minutes. On the other hand, with the control system of the present invention, such passage takes place in less than 20 seconds. Furthermore, there is a saving in the global cycle time with respect to the traditional booths also due to the fact that, when a burner is used the same takes some minutes in obtaining the working temperature, being this minutes added to those needed for actuating the gate in the traditional furnace booths, make therefore the cycle to last the double time.

Furthermore, according to the system of the present invention a direct-fired burner is preferably, but not limitatively, used since with this kind of burner a drying temperature of 80° C. is reached in less than 4 min. whereas with a traditional burner at least 25 min. are needed, being the outer temperature the same.

Furthermore, the system of the present invention provides the use of a pressure transducer which is necessary to measure the pressure inside the booth and to keep it constant by means of the adjustment of the extraction inverter.

Additionally, according the present invention the central control unit can be provided so that it is configured for realising an automatic passage in the painting step. More precisely, once ended the step for preparing the component to be painted inside the booth, when the operator takes the pistol for spraying and starts working, a sensor detects the pressure variation and automatically switches the booth into the painting step.

Furthermore, the configuration of the ventilation groups is such that the central control unit can manage several electro-ventilating groups simultaneously with a single inverter.

Additionally, the central control unit automatically modifies the section of the plenum and/or of the air intake plane to increase the speed of air flow inside the booth. In fact, once ended the painting step, usually it is necessary a flashing step with very fast air flow to quickly remove the exceeding water contained inside the painting product. By restricting the section of the plenum or of the air intake plane the speed increases.

Furthermore, the central control unit can be further configured so as to control automatically the lights in the operating mode of the working step in the booth. More precisely, it can be provided that once ended the painting step, the operator goes outside and switches the booth in drying booth and automatically the outer lights turn off. In case of need, lights could be always be turned on by hand, but after a set time the turning off takes place.

Additionally, according to the present invention, it is provided that the central control unit be able to interface to a modem device in order to manage remotely the control, the programming and the maintenance of the central unit and the peripheral units, thus also being possible to realise a “teleassistance” to the operator.

Furthermore or alternatively, the central control unit can be interfaced to a radio transceiver board or the like, such as a GSM, GPRS, UMTS, etc. network to perform the management of the control unit in place of the modem.

Additionally or alternatively, the central control unit can be interfaced to a remote control unit or remote control of the central control unit. In this way, the operator must not enter or leave the booth to select the steps on the control panel of the distribution board placed outer the booth.

Furthermore or alternatively, the central control unit can be interfaced to the plant network or ethernet or the like, so as to allow the supervision of the system remotely by means of PC remote units or the like, as well as the possibility of programming the painting cycle(s) to be performed for a series of components to be painted in each spray booth.

The table in FIG. 2 illustrates in a schematic way the parameters of the various steps of a whole painting and drying cycle carried out on a car component sample. In the table the values read and obtained with a traditional furnace booth and a booth incorporating a control system (USI Booth) of the present invention are shown.

As it is clear from the analysis results, the furnace booth incorporating the control system of the present invention has a cycle total time which is 36% lower than the time necessary to complete the cycle with a traditional furnace booth, with evident either operating or economical advantages for the operator or the firm which has a booth provided with the control system of the present invention.

1. A system for the control of the painting process in a spray furnace booth comprising a first ventilation group to inlet air inside the booth, a second ventilation group to extract air from said booth, a device for heating the inlet air into the booth and a device for detecting the environment pressure inside the booth,
the system is characterized by the fact of further comprising a PLC central control unit connected to said first ventilation group, said second ventilation group, said device for heating the air and said device for detecting the pressure.

2. The system for the control of the painting process in a spray furnace booth according to claim 1, wherein said central control unit is connected to a device for intercepting and deviating the air conveyed towards/from the inside of the booth, said device being capable to reverse the direction of the conveyed flow upon a predetermined signal coming from said central control unit.

3. The system for the control of the painting process in a spray furnace booth according to claim 1, wherein said central control unit is connected to a device for varying the section of the plenum and of the suction plane inside said booth.

4. The system for the control of the painting process in a spray furnace booth according to claim 1, wherein said central control unit is connected to a valve device for intercepting the air for the paint spraying.

5. The system for the control of the painting process in a spray furnace booth according to claim 1, wherein said central control unit is connected to a sensor device which detects the opened/closed condition of the booth doors.

6. The system for the control of the painting process in a spray furnace booth according to claim 1, wherein said central control unit is connected to a sensor device which detects the environment temperature inside the booth.

7. The system for the control of the painting process in a spray furnace booth according to claim 1, wherein said central control unit is connected to a modem device or the like.

8. The system for the control of the painting process in a spray furnace booth according to claim 1, wherein said central control unit is connected to a GSM data reception/transmission device or the like.

9. The system for the control of the painting process in a spray furnace booth according to claim 1, wherein said central control unit is connected to an ethernet data transmission network or the like.

10. The system for the control of the painting process in a spray furnace booth according to claim 1, wherein said central control unit comprises a display panel.

11. The system for the control of the painting process in a spray furnace booth according to claim 1, wherein said central control unit receives/transmits data from/towards a second remote control unit.

12. The system for the control of the painting process in a spray furnace booth according to claim 1, wherein said device for heating the air inlet in the booth comprises a direct-fired burner.

13. The system for the control of the painting process in a spray furnace booth according to claim 1, wherein said first ventilation group comprises at least a fan connected to an electric motor and an inverter device connected to said electric motor.

14. The system for the control of the painting process in a spray furnace booth according to claim 1, wherein said second ventilation group comprises at least a fan connected to an electric motor and an inverter device connected to said electric motor.

15. A spray furnace booth incorporating the system for the control of the painting process according to claim 1.
